(19) United States
(12) Patent Application Publication
(10) Pub. No.: US 2008/0320603 A1
(43) Pub. Date: Dec. 25, 2008

(54) ACCESS RIGHT MANAGEMENT APPARATUS, ACCESS RIGHT MANAGEMENT METHOD AND RECORDING MEDIUM STORING ACCESS RIGHT MANAGEMENT PROGRAM

(75) Inventor: Yasuhiro ITO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/053,941

(22) Filed: Mar. 24, 2008

(30) Foreign Application Priority Data
Jun. 21, 2007 (JP) 2007-163919

(51) Int. Cl. G06F 21/00

(52) U.S. Cl. 726/28

(57) ABSTRACT

An access right management apparatus, which includes: a management unit that manages permission and denial of access to an electronic document; a request reception unit that receives a request for an access right to access the electronic document; a determination unit that, when the request reception unit receives the request, determines whether or not the access to the electronic document is permitted to a requestor of the request based on the management unit; an access right provision unit that provides the access right to the requestor when the determination unit determines that the access to the electronic document is permitted to the requestor; and a changing unit that changes the denial of the access to the electronic document managed by the management unit to permission according to a history of provision of the access right to the requestor.

### CROSS-REFERENCE TO RELATED APPLICATION

This application is based on and claims priority under 35 USC 119 from Japanese Patent Application No. 2007-163919 filed on Jun. 21, 2007.

### BACKGROUND

1. Technical Field

The present invention relates to an access right management apparatus, an access right management method and a recording medium storing an access right management program.

2. Related Art

There are known techniques for controlling access to electronic documents by setting access rights associated with the electronic documents in a server or the like so that the server controls access to the electronic documents based on the access rights thus set.

### SUMMARY

An aspect of the present invention provides an access right management apparatus, which includes: a management unit that manages permission and denial of access to an electronic document; a request reception unit that receives a request for an access right to access the electronic document; a determination unit that, when the request reception unit receives the request, determines whether or not the access to the electronic document is permitted to a requestor of the request based on the management unit; an access right provision unit that provides the access night to the requester when the determination unit determines that the access to the electronic document is permitted to the requestor; and a changing unit that changes the denial of the access to the electronic document managed by the management unit to permission according to a history of provision of the access right to the requestor.

### BRIEF DESCRIPTION OF THE DRAWINGS

Exemplary embodiments of the present invention will be described in detail based on the following figures, wherein:

FIG. 1 is a diagram showing an example of a system configuration including an access right management apparatus to which the present invention is applied;

FIG. 2 is a diagram showing an example of a functional configuration of the access right management apparatus;

FIG. 3 is diagram showing an example of an access control table for use in a configuration of an illustrative example 1;

FIG. 4 is a diagram showing another example of an access control table for use in a configuration of the illustrative example 1;

FIG. 5 is a flowchart showing an example of flow of processing performed in an access right management apparatus according to the illustrative example 1;

FIG. 6 is a diagram showing an example of an access control table for use in a configuration of an illustrative example 2;

FIG. 7 is a diagram showing another example of an access control table for use in a configuration of the illustrative example 2;

FIG. 8 is a flowchart showing an example of flow of processing performed in an access right management apparatus according to the illustrative example 2;

FIG. 9 is a diagram showing an example of an access control table for use in a configuration of an illustrative example 3;

FIG. 10 is a diagram shown an example of a distribution history recorded by a distribution history recording unit;

FIG. 11 is a graph constructed based on the quantities of access right requests shown in FIG. 10;

FIG. 12 is a diagram showing an example of an access control table for use in a configuration of the illustrative example 3;

FIG. 13 is a flowchart showing an example of flow of processing performed in an access right management apparatus according to the illustrative example 3;

FIG. 14 is a diagram showing an example of an access control table for use in a configuration of an illustrative example 4;

FIG. 15 is a diagram showing an example of a distribution model recorded in a distribution model recording unit;

FIG. 16 is a diagram showing an example of a distribution history recorded by a distribution history recording unit;

FIG. 17 is a diagram showing an example of an access control table for use in a configuration of an illustrative example 4; and

FIG. 18 is a flowchart showing an example of flow of processing performed in an access right management apparatus according to the illustrative example 4.

### DETAILED DESCRIPTION

Exemplary embodiments of an access right management apparatus, an access right management method and a recording medium storing an access right management program according to the present invention will be described in detail with reference to the accompanying drawings.

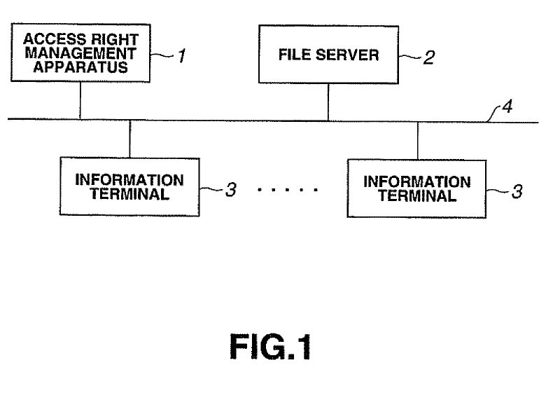

FIG. 1 shows an example of a system configuration including an access right management apparatus 1 according to the present invention.

As shown in FIG. 1, the access right management apparatus 1 is connected to file server 2 and one or more information terminals 3 (e.g. PCs or portable terminals), via a network 4 such as a local area network (LAN).

The access right management apparatus 1 is an apparatus for controlling access to document files stored in the file server 2 (hereafter, referred to as the electronic documents) from users. The term “access” as used herein means various types of actions performed on the electronic documents (for example, viewing, printing, or editing the electronic documents). Specifically, the access right management apparatus 1 manages the right to access to the electronic documents (hereafter, referred to as the access right) for each user or for each group of users. Upon receiving a request for the access right to an electronic document from a user via an information terminal 3, die access right management apparatus 1 checks whether or not the access to that electronic document is permitted. If the access to the electronic document is permitted for the user, the access right management apparatus 1 provides the access right to the electronic document to the user. The user who is granted the access right is allowed to access the electronic document. On the other hand, the access to the electronic document is not permitted to the user, the access right management apparatus 1 will not provide the access right to the electronic document to the user, and hence the user is not allowed to access the electronic document.

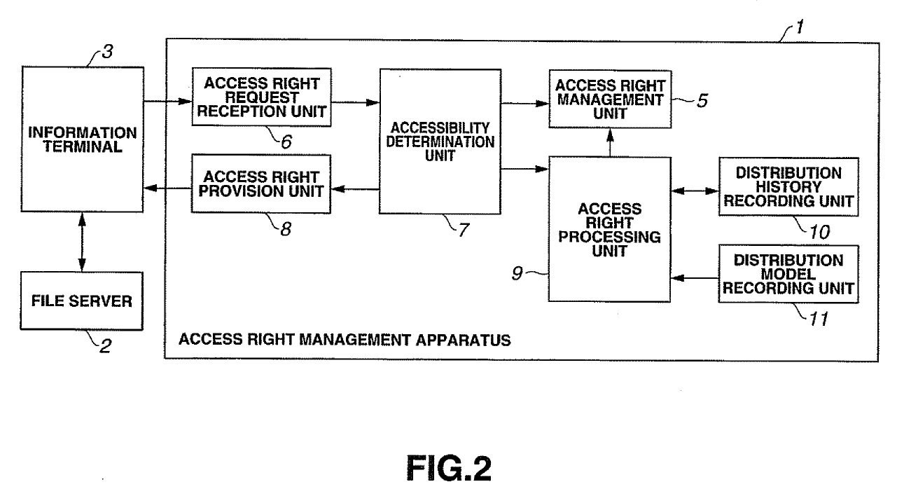

FIG. 2 shows an example of a functional configuration of the access right management apparatus 1.

As shown in FIG. 2, the access right management apparatus 1 includes an access right management unit 5, an access right request reception unit 6, an accessibility determination unit 7, an access right provision unit 8, an access right processing unit 9, a distribution history recording unit 10, and a distribution model recording unit 11.

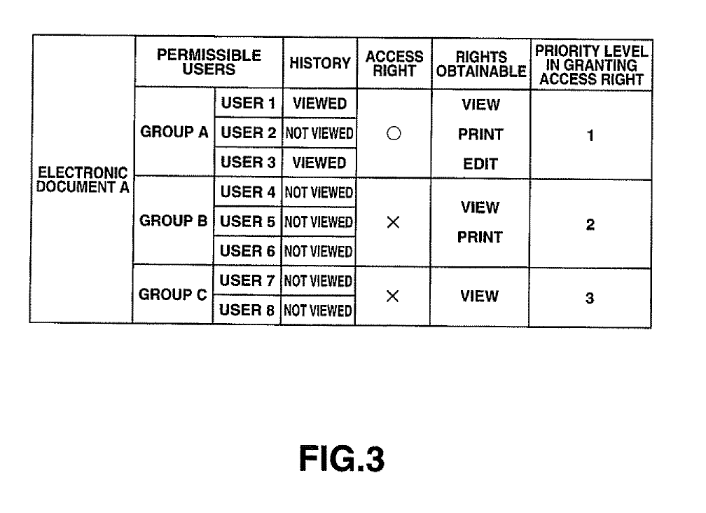

The access right management unit 5 manages the access right to the electronic documents stored in the file server 2 for each user, for each group, or for each information terminal 3. FIG. 3 shows an example of how the access right management unit 5 manages the access right to the electronic documents for each group. Hereafter, the table shown in FIG. 3 shall be referred to as the access control table.

The access right request reception unit 6 receives a request for the access right to an electronic document transmitted by a user using the information terminal 3.

Upon the access right request reception unit 6 receiving the request for the access right to the electronic document from the user, the accessibility determination unit 7 determines whether or not the access to the electronic document is permitted to the user (that is, whether the user is accessible to the electronic document). When the management is performed for each user or group, the determination is made based on identification information such as user IDs or group IDs. When the management is performed for each information terminal 3, the determination is made based on identification information such as MAC addresses or IP addresses.

When the accessibility determination unit 7 determines that the access to the electronic document is permitted to the user, the access right provision unit 8 then provides the access right to the electronic document to the user (that is, the access right provision unit 8 transmits the access right to the information terminal). In contrast, when the accessibility determination unit 7 determines that the access to the electronic document is not permitted to the user, the access right provision unit 8 will not provide the access right to the electronic document to the user (instead, the access right provision unit 8 transmits to the information terminal 3 a message indicating that the access to the electronic document is not permitted).

The access right processing unit 9 performs appropriate processing such as changing (specifically, for example, by granting an access right to a user who is not granted the access right) on the access right information managed by the access right management unit 5 in accordance with a history of provision of access rights to users. This processing of changing the access right information based on the history of provision of the access rights to the users will be described in detail later in the description of illustrative examples 1, 2, 3 and 4.

The distribution history recording unit 10 records a quantity of requests for the access right to electronic documents managed by the access right management unit 5 and a quantity of access rights provided to users (hereafter, referred to as the distribution history) in a storage region of a memory or the like.

The distribution model recording unit 11 is a storage region for storing a predicted distribution history (hereafter, referred to as the distribution model).

It is also possible to employ a configuration in which an access right management program having all the functions of the access right management unit 5, the access right request reception unit 6, the accessibility determination unit 7, the access right provision unit 8, the access right processing unit 9, the distribution history recording unit 10, and the distribution model recording unit 11 is installed in a general-purpose server or computer. In this case, the access right management program is stored in a memory (for example, a hard disk) of the server or computer, and a computing unit (for example, a CPU) of the server or computer executes the access right management program stored in the memory. Further, the access right management program may be provided in the form stored in various types of memories or storage media such as optical disks or the like. The access right management program also may be distributed via a communication line such as a network.

Description will be made of an illustrative example 1, as an example of a configuration in which the access right to an electronic document is managed for each group, and on the condition that all the users in a group to whom the access to the electronic document is permitted view the electronic document, the access to the electronic document is permitted to another group.

FIG. 3 is a diagram showing an example of an access control table for use in the configuration of the illustrative example 1.

As shown in FIG. 3, the access to an electronic document A (for example, viewing, printing, and editing the document) is permitted to users 1, 2 and 3 belonging to a group A. In the situation shown in FIG. 3, the access to an electronic document A (viewing and printing, for example) is not permitted to users 4, 5 and 6 belonging to a group B, and the access to an electronic document A (viewing only, for example) is not permitted to users 7 and 8 belonging to a group C.

As shown in FIG. 3, the first priority in granting the access right is set to the group A, the second priority is set to the group B, and the third priority is set to the group C. This means that, when the users 1, 2 and 3 belonging to the group A having the first priority level in the granting of the access right view the electronic document A, then the access is permitted to the users 4, 5 and 6 belonging to the group B having the second priority level. Further, when the users 4, 5 and 6 belonging to the group B view the electronic document A, then the access is permitted to the users 7 and 8 belonging to the group C having the third priority level in the granting of the access right.

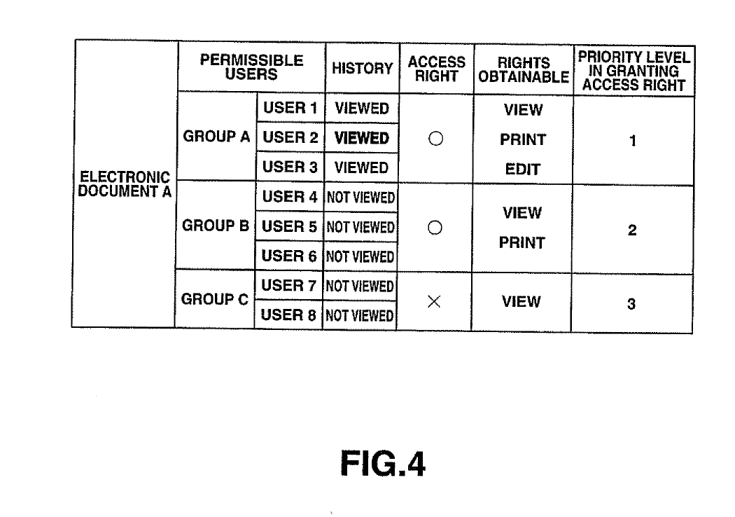

In the access control table shown in FIG. 3, for example, the user 1 and the user 3 already views the electronic document A, but the user 2 does not view the electronic document A yet. If the user 2 ten views the electronic document A, the history of the user 2 is changed from “not viewed” to “viewed” as shown in the access control table of FIG. 4, the access is permitted to the users 4, 5 and 6 belonging to the group B having the second priority level in the granting of the access right, and the symbol to indicate the management state of the access right of the group B is changed from “x” (meaning “not accessible”) to “∘” (meaning accessible) in the access control table shown in FIG. 4.

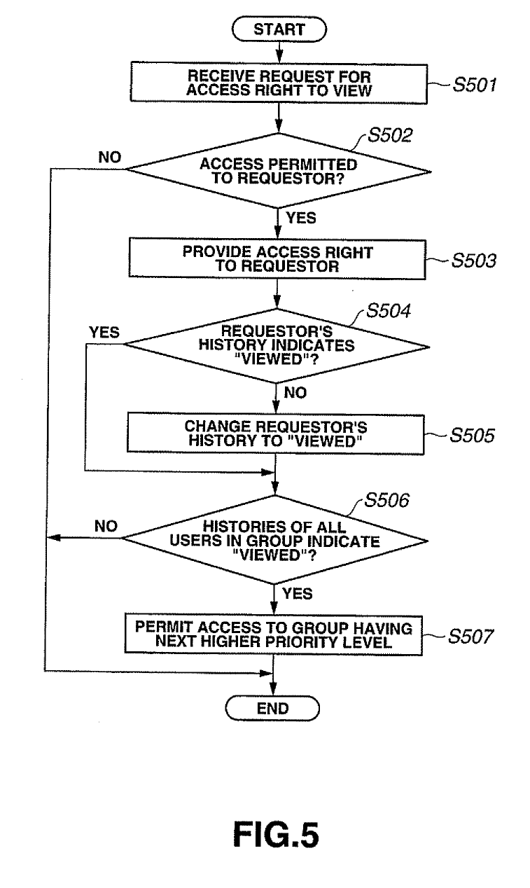

Description will be made of an example of the flow of processing performed by the access right management apparatus 1 according to the illustrative example 1, with reference to the flowchart of FIG. 5.

Upon the access right request reception unit receiving an access right request for viewing an electronic document from an information terminal (S501), the accessibility determination unit refers to the access control table to determine whether the access is permitted to the requestor of the request (S502). When it is determined that the access is not permitted to the requestor (No in S502), the processing procedure is terminated here. If it is determined that the access is permitted to the requestor (YES in S502), the processing proceeds to S503.

When it is determined that the access is permitted to the requestor (YES in S502), the access right provision unit provides the access right to the requestor (S503), while the access right processing unit refers to the access control table to check whether or not the requestor's history indicates “viewed” (S504). If the requestor' history indicates “viewed” (S504 in YES), the processing proceeds to S506. If the requestor's history indicates “not viewed” (NO in S504), the processing proceeds to S505.

When the requestor's history indicates “not viewed” (NO in S504), the access right processing unit changes the requestor's history in the access control table to “viewed” (S505), and the processing proceeds to S506.

The access right processing unit then checks whether the histories of all the users in the group to which the requestor belongs indicate “viewed” or not (S506). If not all the histories of the users in the group indicate “viewed” (NO in S506), the processing procedure is terminated here. If the histories of all the users in the group indicate “viewed” (YES in S506), the processing proceeds to S507.

When the histories of all the users in the group indicate “viewed” (YES in S506), the access right processing unit grants the access right to the users belonging to the group having the next higher priority level (S507), and the processing procedure is terminated.

Description will be made of an illustrative example 2 as an example of a configuration in which the access right to an electronic document is managed for each group, and on the condition that all the users in a group to whom the access to the electronic document is permitted have downloaded the electronic document, the access to the electronic document is permitted to another group.

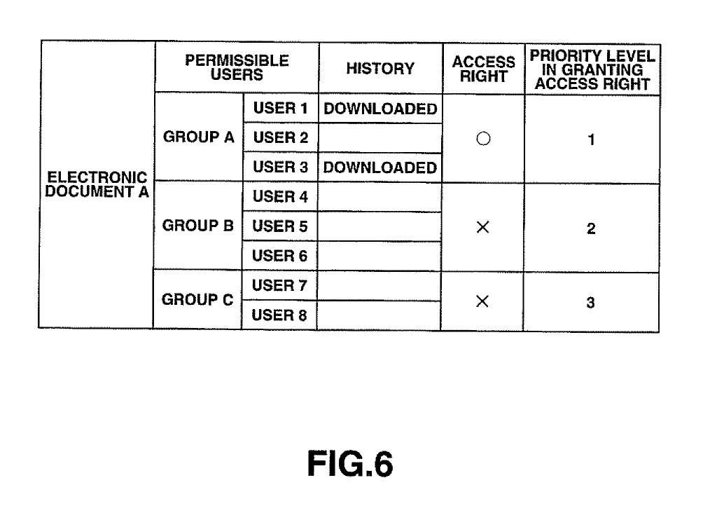

FIG. 6 is a diagram showing an example of an access control table for use in the configuration of the illustrative example 2.

As shown in FIG. 6, the access right to download an electronic document A is granted to users 1, 2 and 3 belonging to a group A. In the situation shown in FIG. 6, the access right to download the electronic document A is not granted to users 4, 5, and 6 belonging to a group B, and the access right to download the electronic document A is not granted either to users 7 and 8 belonging to a group C.

As shown in FIG. 6, the first priority in granting the access right is set to the group A, the second priority in granting the access right is set to the group B, and the third priority in granting the access right is set to the group C. This means that when the users 1, 2 and 3 belonging to the group A having the first priority level in the granting of the access right download the electronic document A, then the access is permitted to the users 4, 5 and user 6 belonging to the group B having the second priority level. Further, when the users 4, 5 and 6 belonging to the group B download the electronic document A, then the access is permitted to the users 7 and 8 belonging to the group C having the third priority level in the granting of the access right.

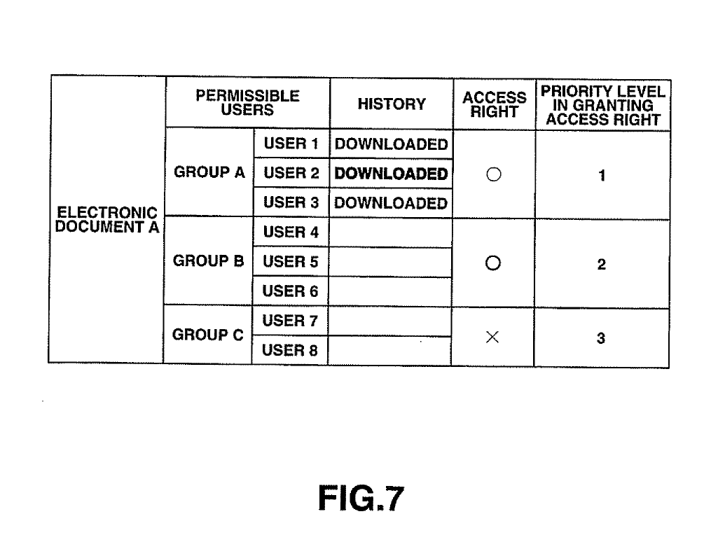

In the access control table shown in FIG. 6, for example, the user 1 and the user 3 already download the electronic document A, while the user 2 does not yet download the electronic document A. When the user 2 then downloads the electronic document A, the history of the user 2 is changed to “downloaded” in the access control table shown in FIG. 7, and the access is permitted to the users 4, 5 and 6 belonging to the group B having the second priority level in the granting of the access right. The symbol to indicate the management state of the access right of the group B is changed from “x” (meaning “not accessible”) to “∘” (meaning accessible) in the access control table shown in FIG. 7.

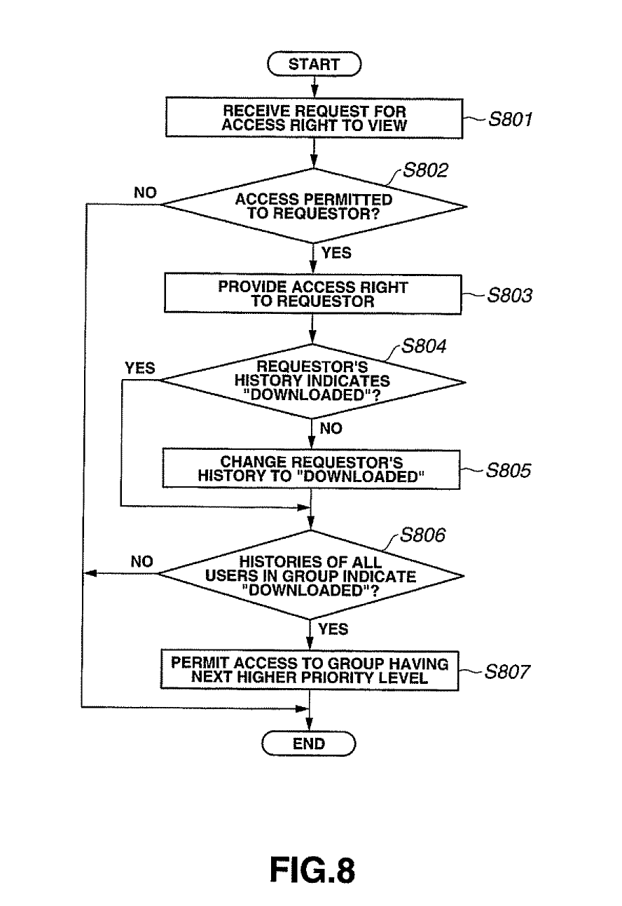

Description will be made of an example of the flow of processing performed by the access right management apparatus 1 according to the configuration of the illustrative example 2, with reference to the flowchart of FIG. 8.

Upon the access right request reception unit receiving from an information terminal an access right request for downloading (S801), the accessibility determination unit refers to the access control table to determine whether the access is permitted to the requestor of the request (S802). If it is determined that the access is not permitted to the requestor (NO in S802), the processing procedure is terminated. If it is determined that the access is permitted to the requestor (YES in S802), the processing proceeds to S803.

When it is determined that the access is permitted to the requestor (YES in S802), the access right provision unit provides the access right to the requestor (S803), while the access right processing unit refers to the access control table to check whether the requestor's history indicates “downloaded” or not (S804). If the requestor's history indicates “downloaded” (YES in S804), the processing proceeds to S806. If the requestor's history does not indicate “downloaded” (NO in S804), the processing proceeds to S805.

If the requestor's history does not indicate “downloaded” (NO in S804), the access right processing unit changes the requestor's history in the access control table to “downloaded” (S805), and the processing proceeds to S806.

The access right processing unit then checks whether the histories of all the users in the group to which the requestor belongs indicate “downloaded” or not (S806). If not all the histories of the users in the group indicate “downloaded” (NO in S806), the processing procedure is terminated here. If the histories of all the users in the group indicate “downloaded” (YES in S806), the processing proceeds to S807.

When the histories of all the users in the group indicate “downloaded” (YES in S806), the access right processing unit grants the access right to the users belonging to the group having the next higher priority level (S807), and the processing procedure is terminated.

A configuration in which the management state of the access right is changed according to the distribution history of an electronic document will be described as an illustrative example 3.

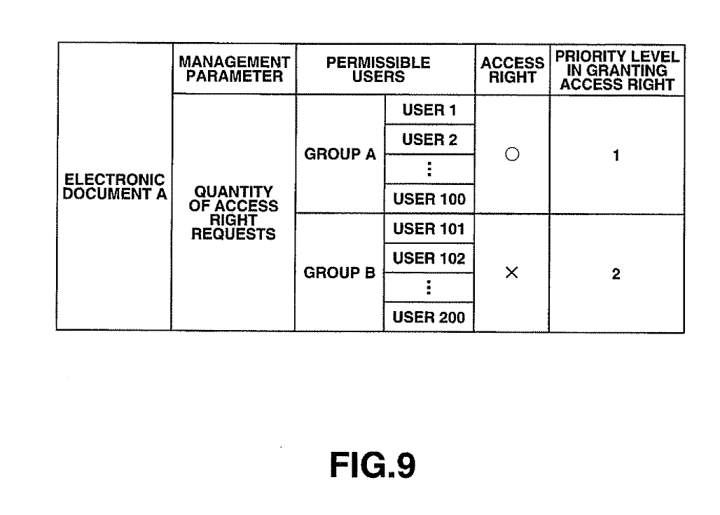

FIG. 9 is a diagram showing an example of an access control table used in the configuration of the illustrative example 3.

As shown in FIG. 9, when the quantity of access right requests is set as a management parameter in the access control table, the distribution history recording unit 10 records the quantity of requests for the access right to the electronic document A as a distribution history, and when the distribution history of one group satisfies a specific requirement, the access right processing unit 9 grants the access right to the electronic document A to another group. The following description of the illustrative example 3 will be made in terms of an example in which the specific requirement is considered to be satisfied when the quantity of access right requests as the distribution history reaches its peak value.

As shown in FIG. 9, the access to the electronic document A is permitted to users 1 to 100 belonging to a group A. On the other hand, the access to the electronic document A is not permitted to users 101 to 200 belonging to a group B.

As shown in FIG. 9, the first priority in granting the access right is set to the group A, and the second priority in granting the access right is set to the group B. This means that, when the quantity of access right requests of the group A reaches the peak value, the access is permitted to the users 101 to 200 belonging to the group B having the second priority level in the granting of the access right.

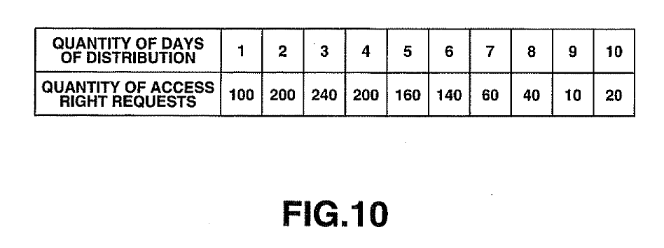

FIG. 10 is a diagram showing an example of a distribution history recorded by the distribution history recording unit 10.

As shown in FIG. 10, the distribution history recording unit 10 records a quantity of access right requests for the electronic document A for each day of distribution. In the example shown here, the quantity of access right requests on the first day is 100, the quantity recorded on the second day is 200, the quantity recorded on the third day is 240, the quantity recorded on the fourth day is 200, the quantity recorded on the fifth day is 160, the quantity recorded on the sixth day is 140, the quantity recorded on the seventh day is 60, the quantity recorded on the eighth day is 40, the quantity recorded on the ninth day is 10, and the quantity is recorded on the tenth day is 20. Therefore, it can be seen that the quantity of access right requests reaches its peak on the third day of distribution.

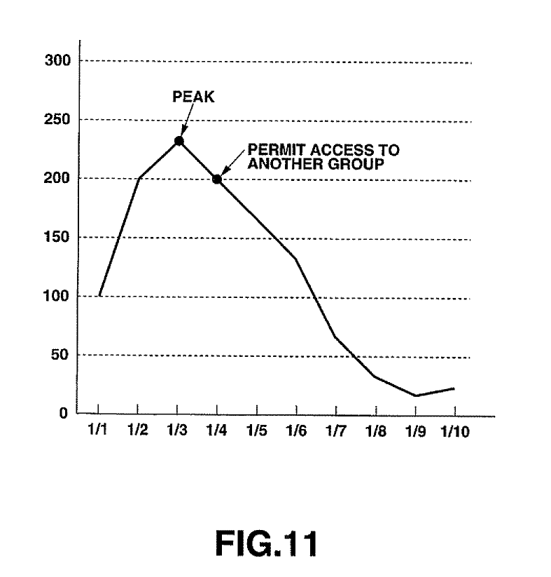

FIG. 11 is a graph constructed based on the quantities of access right requests shown in FIG. 10.

It can be seen also from the graph of the FIG. 11 that the quantity of access right requests reaches its peak on the third day of distribution.

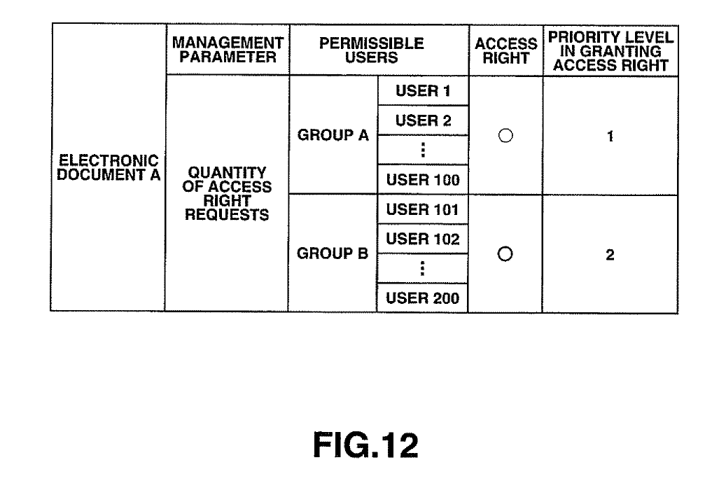

Accordingly, the access right processing unit 9 grants, on the fourth day of distribution, the access right to the users 1001 to 200 belonging to the group 13 having the second priority level in the granting of the access right, and the symbol to indicate the management state of the access right of the group B is changed from “x” (meaning “not accessible”) to “∘” (meaning accessible) in the access control table shown in FIG. 12.

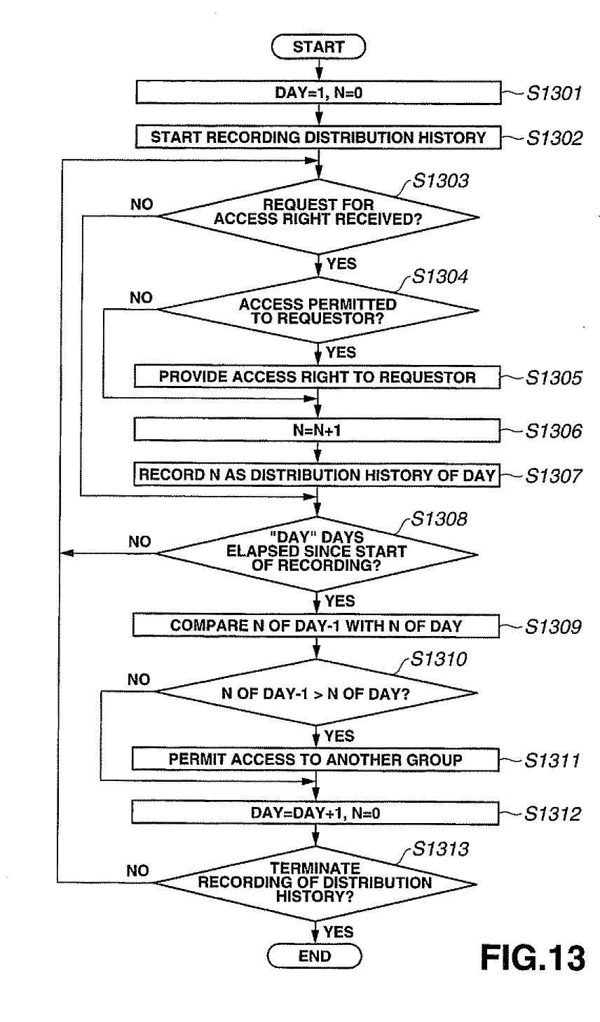

Description will be made of an example of the flow of processing performed by the access right management apparatus 1 according to the configuration of the illustrative example 3, with reference to the flowchart of FIG. 13.

The distribution history recording unit sets “1” to the day of distribution DAY while setting “0” to the quantity of access right requests N (S1301), and starts recording the distribution history (S1302).

When the access right request reception unit receives an access right request from an information terminal (YES in S1303), the processing proceeds to S1304. In contrast, when the access right request reception unit receives no access right request from an information terminal (NO in S1303), the processing proceeds to S1308.

When the access right request reception unit receives an access right request from an information terminal (YES in S1303), the accessibility determination unit refers to the access control table to determine whether the access is permitted to the requestor of the request (S1304). If it is determined that the access is not permitted to the requestor (NO in S1304), the processing proceeds to S1306. In contrast, if it is determined that the access is permitted to the requestor (YES in S1304), the processing proceeds to S1305.

When it is determined that the access is permitted to the requestor (YES in S1304), the access right provision unit provides the access right to the requestor (S1305), and the processing proceeds to S1306.

The distribution history recording unit then increments the quantity of access right requests N by one (S1306), and records the quantity of access right requests N as the distribution history for the day of distribution DAY (S1307). The processing proceeds to S1308.

The distribution history recording unit checks whether “DAY” days elapses since the start of the recording of the distribution history (S1308). More specifically, if the value of DAY in the distribution history is “1”, the distribution history recording unit checks whether “one” day elapses since the start of the recording of the distribution history. If the value of DAY in the distribution history is “2”, it checks whether “two” days elapses since the start of the recording of the distribution history. If the value of DAY in the distribution history is “m”, it checks whether “in” days elapses since the start of the recording of the distribution history.

If “DAY” days does not elapse since the start of the recording of the distribution history (No in S1308), the processing returns to S1303, whereas if “DAY” days elapses since the start of the recording of the distribution history (YES in S1308), the processing proceeds to S1309.

When “DAY” days elapses since the start of the recording of the distribution history (YES in S1308), the access right processing unit refers to the distribution history to compare the quantity of access right requests N on the (DAY−1)-th day (namely, the quantity of access right requests on the preceding day) with the quantity of access right requests N on the DAY-th day (namely, the quantity of access right requests on the present day) (S1309). If the quantity of access right requests N on the (DAY−1)th day is smaller than the quantity of access right requests N on the DAY-th day (NO in S1310), the processing proceeds to S1312. If the quantity of access right requests N on the (DAY−1)th day is greater than the quantity of access right requests N on the DAY-th day (YES in S1310), the processing proceeds to S1311.

When the quantity of access right requests N on the (DAY−1)th day is greater than the quantity of access right requests N on the DAY-th day (YES in S1310), the access right processing unit grants the access to the users belonging to the group having the next higher priority level (S1311), and the processing proceeds to S1312.

The distribution history recording unit then increments the value of the day of distribution DAY by one, while setting “0” to the quantity of access right requests N (S1312). If the recording of the distribution history is to be continued (NO in S1313), the processing returns to S1303. In contrast, if the recording of the distribution history is to be terminated (YES in S1313), the processing procedure is terminated.

It is also possible to record not only the quantity of access right requests but also the quantity of viewing, the quantity of printing, or the quantity of downloading as the distribution history.

Description will be made of a configuration in which the management state of the access right is changed according to a comparison result between the distribution history and a distribution model for an electronic document, as an illustrative example 4.

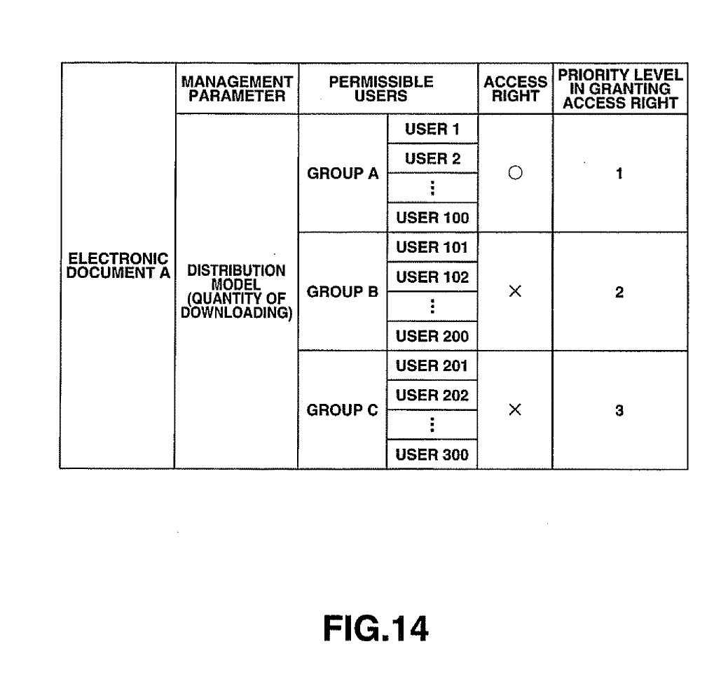

FIG. 14 is a diagram showing an example of an access control table used in the configuration of the illustrative example 4.

As shown in FIG. 14, when a distribution model (a quantity of downloading) is set as a management parameter in the access control table, the distribution history recording unit 10 records a quantity of times the electronic document A is downloaded by one group as a distribution history, and the access right processing unit 9 compares this distribution history with distribution model for the electronic document A recorded in the distribution model recording unit. If the comparison result satisfies a specific requirement, the access to the electronic document A is permitted to another group. The following description of the illustrative example 4 will be made in terms of an example in which the specific requirement is considered to be satisfied when the value of the distribution history is within an allowable range of the distribution model and reaches an access right changing point set for the distribution model.

As shown in FIG. 14, the access to the electronic document A is permitted to users 1 to 100 belonging to a group A. In the situation shown in FIG. 14, the access to the electronic document A is not permitted to users 101 to 200 belonging to a group B, and to users 201 to 300 belonging to a group C.

As shown in FIG. 14, the first priority in granting the access right is set to the group A, the second priority in granting the access right is set to the group B, and the third priority in granting the access right is set to the group C. This means that when the value of the distribution history is within the allowable range of the distribution model and reaches the first access right changing point set for the distribution model, the access right is granted to the users 101 to 200 belonging to the group B having the second priority level in the granting of the access right. Further, when the value of the distribution history is within the allowable range of the distribution model and reaches the second access right changing point set for the distribution model, the access right is granted to the users 201 to 300 belonging to the group C having the third priority level in the granting of the access right.

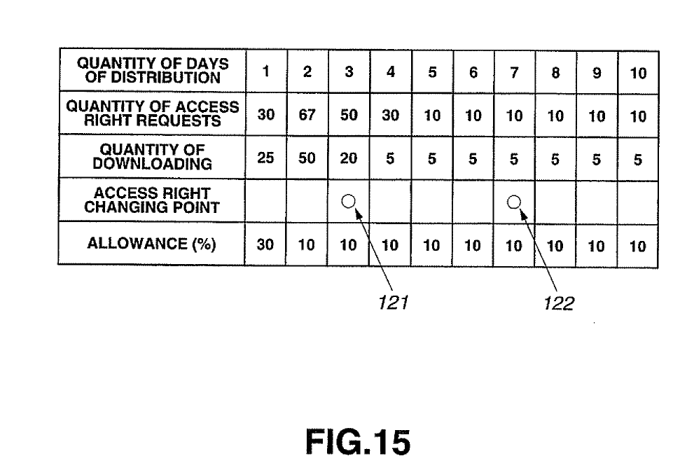

FIG. 15 is a diagram showing an example of a distribution model stored in the distribution model recording unit 11.

As shown in FIG. 15, the distribution model consists of a predicted quantity of access right requests for the electronic document A and a predicted quantity of downloading of the electronic document A for each day of distribution. It can be seen from FIG. 15 that, for the first day of distribution, the predicted quantity of access right requests is 30 while the predicted quantity of downloading is 25. For the second day, the predicted quantity of access right requests is 67 while the predicted quantity of downloading is 50. For the third day, the predicted quantity of access right requests is 50 while the predicted quantity of downloading is 20. For the fourth day, the predicted quantity of access right requests is 30 while the predicted quantity of downloading is 5. For the fifth to tenth days, the predicted quantity of access right requests is 10 while the predicted quantity of downloading is 5.

As shown in FIG. 15, an allowance (%) is set for the predicted quantity of access right requests and the predicted quantity of downloading in the distribution model. For example, the allowance is set to 30% for the first day of distribution. Therefore, if the history of the quantity of access right requests exhibits a value within the range of 30±9 (i.e. from 21 to 39), it is determined that the value of the distribution history is within the allowable range of the distribution model. If the quantity of downloading of the first day is within the range of 25±7.5 (i.e. from 17.5 to 32.5), it is determined that the value of the distribution history is within the allowable range of the distribution model. In the example shown in FIG. 15, the allowance is set to 10% for the second to tenth days of distribution.

As shown in FIG. 15, an access right changing point is set for the distribution model. In the distribution model shown in FIG. 15, a first access right changing point 121 is set to the third day of distribution, and a second access right changing point 122 is set to the seventh day of distribution. For example, if the history of both or either the quantity of access right requests and the quantity of downloading exhibits a value or values within the allowable range of the distribution model from the first day to the third day of distribution, the access right is granted to the users 101 to 200 belonging to the group B having the second priority level in the granting of the access right. If the history of both or either the quantity of access right requests and the quantity of downloading exhibits a value or values within the allowable range of the distribution model from the first day to the seventh day of distribution, the access right is granted to the users 201 to 300 belonging to the group C having the third priority level in the granting of the access right.

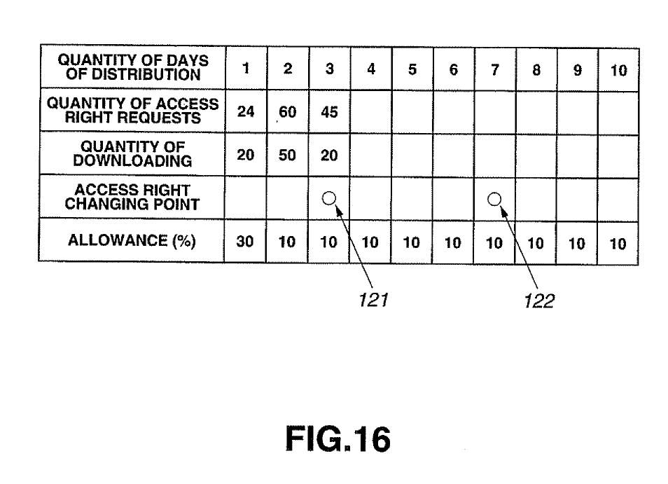

FIG. 16 is a diagram showing an example of a distribution history recorded by distribution history recording unit 10.

As shown in FIG. 16, the distribution history recording unit 10 records a quantity of access right requests and a quantity of downloading for the electronic document A for each day of distribution. It can be seen from FIG. 16 that, for the first day of distribution, the quantity of access right requests is 24 while the quantity of downloading is 20. For the second day, the quantity of access right requests is 60 while the quantity of downloading is 50. For the third day, the quantity of access right requests is 45 while the quantity of downloading is 20.

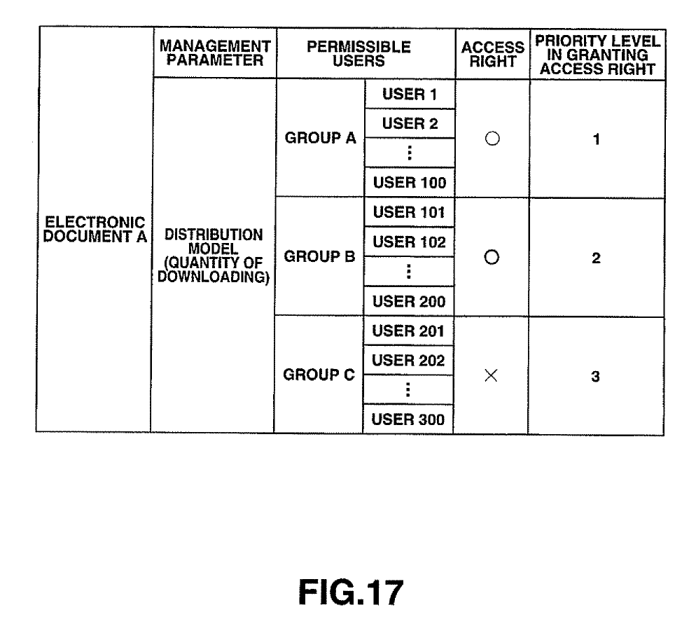

Since the quantity of downloading of 20 of the first day of distribution is within the range of 25±7.5, it is determined that the quantity of downloading of the first day is within the allowable range of the distribution model. Since the quantity of downloading of 50 of the second day of distribution is within the range of 50±5, it is determined that the quantity of downloading of the second day is within the allowable range of the distribution model. Since the quantity of downloading of 20 of the third day of distribution is within the range of 20±2, it is determined that the quantity of downloading of the third day is within the allowable range of the distribution model. Accordingly, on the third day of distribution to which the first access right changing point 121 is set, the access right processing unit grants the access right to the users 101 to 200 belonging to the group B having the second priority level in the granting of the access right. As a result, the symbol to indicate the management state of the access right of the group B is changed from “x” (meaning “not accessible”) to “∘” (meaning accessible) in the access control table shown in FIG. 17.

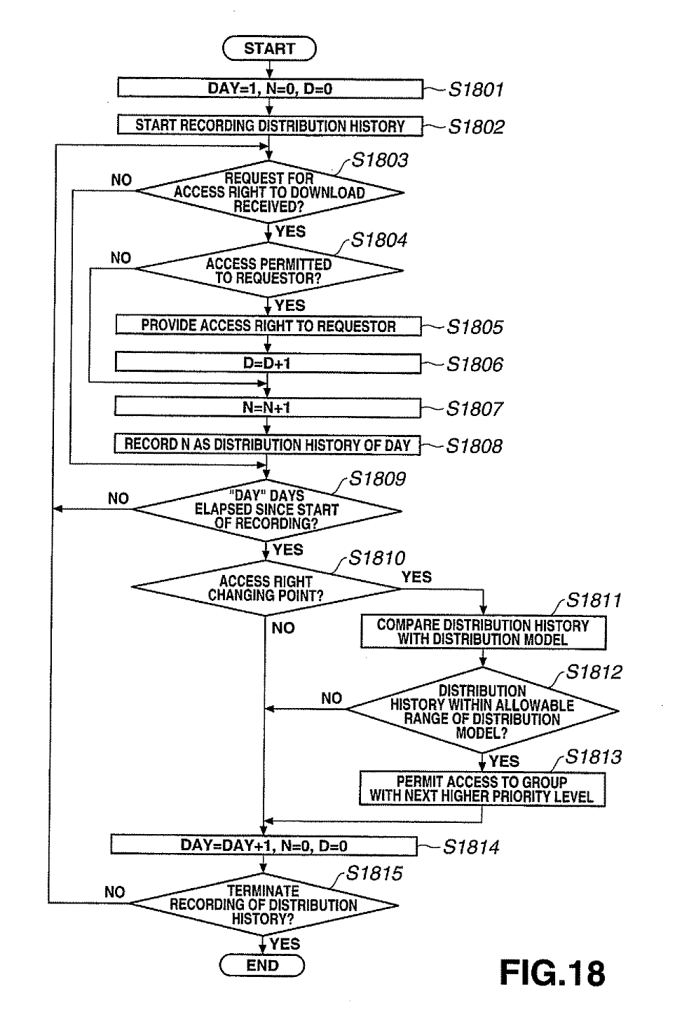

Description will be made of an example of processing performed by the access right management apparatus 1 according to the configuration of the illustrative example 4, with reference to the flowchart of FIG. 18.

The distribution history recording unit sets “1” to the day of distribution DAY while setting “0” to the quantity of access right requests N (S1801), and starts recording the distribution history (S1802).

When the access right request reception unit receives an access right request from an information terminal (YES in S1803), the processing proceeds to S1804. In contrast, when the access right request reception unit receives no access right request from an information terminal (NO in S1803), the processing proceeds to S1809.

When the access right request reception unit receives from an information terminal an access right request for downloading (YES in S1803), the accessibility determination unit refers to the access control table to determine whether or not the access is permitted to the requestor of the request (S1804). If it is determined that the access is not permitted to the requestor (NO in S1804), the processing proceeds to S1807. In contrast, if it is determined that the access is permitted to the requester (YES in S1804), the processing proceeds to S1805.

When it is determined that the access is permitted to the requester (YES in S1804), the access right provision unit provides the access right to the requester (S1805), and the distribution history recording unit increases the value of the quantity of downloading D by one (S1806). The processing then proceeds to S1807.

The distribution history recording unit increases the value of the quantity of access right requests N by one (S1807), and records the quantity of access right requests N as the distribution history of the day of distribution DAY (S1808). The processing then proceeds to S1809.

The distribution history recording unit checks whether “DAY” days have elapsed since the start of the recording of the distribution history (S1809). More specifically if the value of DAY in the distribution history is “1”, the distribution history recording unit checks whether “one” day elapses since the start of the recording of the distribution history. If the value of DAY in the distribution history is “2”, it checks whether “two” days elapses since the start of the recording of the distribution history. If the value of DAY in the distribution history is “m”, it checks whether “m” days elapses since the start of the recording of the distribution history.

If “DAY” days does not elapse since the start of the recording of the distribution history (No in S1809), the processing returns to S1803, whereas if “DAY” days elapses since the start of the recording of the distribution history (YES in S1809), the processing proceeds to S1810.

When “DAY” days elapses since the start of the recording of the distribution history (YES in S1308), the access right processing unit refers to the distribution model to check whether or not the access right changing point is set to the (DAY)th day (S1810). If the access right changing point is not set (NO in S1810), the processing proceeds to S1814. If the access right changing point is set (YES in S1810), the processing proceeds to S1811.

When the access right changing point is set (YES in S1810), the access right processing unit compares the distribution history with the distribution model (S1811). If the value of the distribution history is out of the allowable range of the distribution model (NO in S1812), the processing proceeds to S1814. In contrast, if the value of the distribution history is within the allowable range of the distribution model (YES in S1812), the processing proceeds to S1813.

When the value of the distribution history is within the allowable range of the distribution model (YES in S1812), the access right processing unit grants the access right to the users belonging to the group having the next higher priority level (S1813), and then the processing proceeds to S1814.

The distribution history recording unit then increases the value of the day of distribution DAY by one, and sets “0” to the quantity of access right requests N, while setting “0” to the quantity of downloading D (S1814). If the recording of the distribution history is to be continued (NO in S1815), the processing returns to S1803. If the recording of the distribution history is terminated (YES in S1815), the processing procedure is terminated here.

Alternatively, it is also possible to change the management state of the access right by combining the configurations as described in relation to the illustrative examples 1, 2, 3 and 4.

The foregoing description of the exemplary embodiments of the present invention is provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An access right management apparatus comprising:
a management unit that manages permission and denial of access to an electronic document;
a request reception unit that receives a request for an access right to access the electronic document;
a determination unit that, when the request reception unit receives the request, determines whether or not the access to the electronic document is permitted to a requestor of the request based on the management unit;
an access right provision unit that provides the access right to the requester when the determination unit determines that the access to the electronic document is permitted to the requestor; and
a changing unit that changes the denial of the access to the electronic document managed by the management unit to permission according to a history of provision of the access right to the requestor.

2. The access right management apparatus according to claim 1, wherein:
the management unit sets permission or denial of the access to the electronic document and a priority level in the permission of the access for each of requestors; and
the changing unit changes the denial of the access to the electronic document for the requestor to permission according to the priority level.

3. The access right management apparatus according to claim 2, wherein, when the access right is provided to all the requesters to whom the access to the electronic document is permitted, the changing unit changes the denial of the access to the electronic document to permission for a requestor having the next higher priority level.

4. The access right management apparatus according to claim 2, further comprising a request quantity recording unit that records a quantity of access right requests received by the request reception unit,
wherein the changing unit changes the denial of the access to the electronic document for the requestor to permission according to the priority level in the permission when the quantity of access right requests recorded by the recording unit satisfies a specific requirement.

5. The access right management apparatus according to claim 4, further comprising
a predicted request quantity storing unit that stores a predicted quantity of access right requests; and
a request quantity comparison unit that compares the quantity of access right requests recorded by the request quantity recording unit with the predicted quantity stored in the predicted request quantity storing unit,
wherein the changing unit changes the denial of the access to the electronic document for the requestor to permission according to the priority level in the permission when it is determined by the request quantity comparison unit that the quantity of access right requests is within an allowable range of the predicted quantity.

6. The access right management apparatus according to claim 2, further comprising:
a provision quantity recording unit that records the quantity of access rights provided to the requestor by the access right provision unit,
wherein the changing unit changes the denial of the access to the electronic document for the requestor to permission according to the priority level in the permission when the quantity of provided access rights recorded by the provision quantity recording unit satisfies a specific requirement.

7. The access right management apparatus according to claim 4, further comprising:
a provision quantity recording unit that records the quantity of access rights provided to the requestor by the access right provision unit,
wherein the changing unit changes the denial of the access to the electronic document for the requestor to permission according to the priority level in the permission when the quantity of provided access rights recorded by the provision quantity recording unit satisfies a specific requirement.

8. The access right management apparatus according to claim 5, further comprising
a predicted provision quantity storing unit that stores the predicted quantity of provided access rights; and
a provision quantity comparison unit that compares the quantity of the provided access rights recorded by the provision quantity recording unit with the predicted quantity stored in the predicted provision quantity storing unit,
wherein the changing unit changes the denial of the access to the electronic document for the requestor to permission according to the priority level in the permission when it is determined by the provision quantity comparison unit that the quantity of provided access rights is within an allowable range of the predicted quantity.

9. The access right management apparatus according to claim 6, further comprising:
a predicted provision quantity storing unit that stores a predicted quantity of provided access rights; and
a provision quantity comparison unit that compares the quantity of the provided access rights recorded by the provision quantity recording unit with the predicted quantity stored in the predicted provision quantity storing unit,
wherein the changing unit changes the denial of the access to the electronic document for the requestor to permission according to the priority level in the permission when it is determined by the provision quantity comparison unit that the quantity of provided access rights is within an allowable range of the predicted quantity.

10. An access right management method comprising:
managing permission and denial of access to an electronic document;
receiving a request for an access right to access the electronic document;
determining, upon receiving the request, whether or not the access to the electronic document is permitted to a requester of the request;
providing the access right to the requester when it is determined that the access to the electronic document is permitted to the requestor; and
changing the denial of the access to the electronic document to permission according to a history of provision of the access right to the requestor.

11. A computer readable recording medium storing a access right management program for causing a computer to execute a process, the process comprising:
managing permission and denial of access to an electronic document,
receiving a request for an access right to access to the electronic document;
determining, upon receiving the request, whether or not the access to the electronic document is permitted to a requestor of the request;
providing the access right to the requestor when it is determined that the access to the electronic document is permitted to the requestor; and
changing the denial of the access to the electronic document for the requestor to permission according a history of the provision of the access right to the requestor.
